(19) United States
(12) Patent Application Publication
(10) Pub. No.: US 2022/0067213 A1
(43) Pub. Date: Mar. 3, 2022

(54) Subliminal Software Detection

(71) Applicant: Lindsey S, Lieb, Knoxville, TN (US)

(72) Inventor: Lindsey S, Lieb, Knoxville, TN (US)

(21) Appl. No.: 17/446,451

(22) Filed: Aug. 30, 2021

Related U.S. Application Data
(60) Provisional application No. 63/072,381, filed on Aug. 31, 2020.

(51) Int. Cl. G06F 21/64; G06K 9/62; G06F 21/52

(52) U.S. Cl. CPC G06F 21/64; G06F 21/52; G06K 9/6215

(57) ABSTRACT

A method for detecting and acting upon a variance in an electronic device of a user, the method comprising the steps of monitoring operation of the electronic device for anomalies in streams of at least one of visual, audio, or haptic data to locate a variance in video frames, audible frequencies, and haptic patterns, recording the variance, alerting the user to the variance, receiving a confirmation from the user in regard to the variance, and initiating a response to the variance in associated electronic devices.

### FIELD

This disclosure relates to the field of electronic device security. More particularly, this disclosure relates to detection and analysis of surreptitious software.

### INTRODUCTION

Users rely heavily upon their electronic devices, such as cell phones, personal digital assistants, tablets, computers, and wearables. Part of this reliance stems from the fact that many users put highly sensitive information on their electronic devices, and trust their electronic devices implicitly. Because of this high level of trust, malefactors are incentivized to infiltrate such electronic devices with surreptitious software that either steals sensitive information from these devices, or causes the user to alter their thinking or behavior in some way.

For example, a malefactor could place surreptitious software on a user's device that displayed subliminal images on the user's device, or images that are displayed for a period of time that is greater than subliminal, in an effort to influence the thinking or behavior of the user.

At the present time, there is no known method for a user to detect and act upon such surreptitious software.

What is needed, therefore, is a system that tends to reduce issues such as those described above, at least in part.

### SUMMARY

The above and other needs are met by a method for detecting and acting upon a variance in an electronic device of a user, the method comprising the steps of monitoring operation of the electronic device for anomalies in streams of at least one of visual, audio, or haptic data to locate a variance in video frames, audible frequencies, and haptic patterns, recording the variance, alerting the user to the variance, receiving a confirmation from the user in regard to the variance, and initiating a response to the variance in associated electronic devices.

An apparatus for detecting and acting upon a variance in an electronic device of a user, the apparatus comprising a processor for monitoring operation of the electronic device for anomalies in streams of at least one of visual, audio, or haptic data to locate a variance in video frames, audible frequencies, and haptic patterns, a memory for recording the variance, an interface for alerting the user to the variance, the interface further for receiving a confirmation from the user in regard to the variance, and an output for initiating a response to the variance in associated electronic devices.

A non-transitory, computer-readable storage medium having stored thereon a computer program comprising a set of instructions for causing the computer to perform the steps of monitoring operation of an electronic device for anomalies in streams of at least one of visual, audio, or haptic data to locate a variance in video frames, audible frequencies, and haptic patterns, recording the variance, alerting a user to the variance, receiving a confirmation from the user in regard to the variance, and initiating a response to the variance in associated electronic devices.

In various embodiments according to these aspects of the present disclosure, the anomalies include an image that is presented for less than a given length of time and the image differs from a preceding image and a succeeding image by more than a given amount. In some embodiments, the anomalies include a series of audio tones that is presented for less than a given length of time and the series of audio tones differs from a preceding series of audio tone and a succeeding series of audio tones by more than a given amount. In some embodiments, the given length of time is about one second. In some embodiments, the anomalies include a haptic signal that is unrelated to the user's operation of the electronic device.

### DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a flow chart of a method to detect and act upon surreptitious software, according to an embodiment of the present disclosure.

FIG. 2 is a functional block diagram of a device to detect and act upon surreptitious software, according to an embodiment of the present disclosure.

### DESCRIPTION

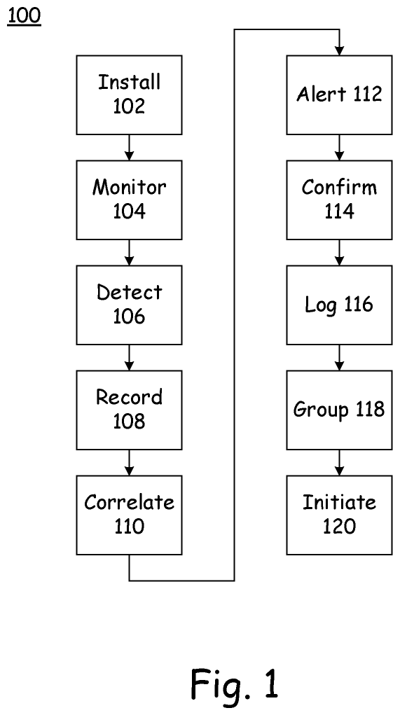

With reference now to FIG. 1, there is depicted a flow chart of a method 100 to detect and act upon surreptitious software, according to an embodiment of the present disclosure. It is appreciated that the steps of the method are depicted in FIG. 1 in a certain order, but that in various embodiments, the steps can be performed in alternative orders of operation. Further, in some embodiments, either a lesser or a greater number of steps can be performed as a part of the method. Also, in some embodiments the method is embodied in software on a non-transitory medium, or in a computing device.

In the embodiment depicted, the first step is to install the monitor software as given in block 102. The installation process proceeds according to the specifics of the electronic device upon which it is to operate. For example, for a cell phone, the monitor software can be loaded such as through Google Play Store or iTunes. In other embodiments the monitor software can be loaded onto the electronic device from a physical medium, such as a flash drive, which the user has purchased. Other embodiments for loading the monitor software are also comprehended.

Once installed and activated, the monitor software starts monitoring the operation of the electronic device, as given in block 104. In the example currently used, where the monitor software is operational to detect the presence and operation of surreptitious software that displays subliminal image presentations, the step 104 of monitoring the operation of the electronic device includes processes such as monitoring the information that is sent to the display of the electronic device, and measuring the length of time that such images are displayed. If an image is displayed for less than a given length of time, then the monitor software triggers a detection, such as given in block 106. If the length of time that the image is displayed is greater than a given length of time, then it is assumed that the user consciously perceives the image, and even if the display of the image is unwanted, the user is able to consciously do something about it.

In other embodiments, the step 104 of monitoring the operation of the electronic device includes processes such as anomalies or inconsistencies in the output or internal streams of at least one of visual, audio, or haptic data to locate variances in video frames, audible frequencies, haptic patterns, and so forth.

Once such a variance is detected as given in block 106, the variance is recorded, as given in block 108. Further, the specific variance is correlated, as given in block 110, to determine whether is has been seen before and whether it is being repeated on the device.

The user of the device is alerted, as given in block 112, with the information known to the method 100, which allows the user to confirm whether the variance is something undesirable, or whether the variance is something that is known to be acceptable to the user, as given in block 114. Regardless of the response by the user, the method 100 can log the variance, as given in block 116, so as to have an additional record of both the variance itself, the metadate associated with the variance, and the user's response to the variance. The method 100 can also, in some embodiments, group the variance with other variances that have been logged, as given in block 118, as to various common properties of the variance. As given in block 120, the method 100 can also initiate a more specific monitoring routine 104 in either the electronic device in which the variance was detected, or other associated electronic devices—such as those that belong to a common subscription service—so that the given variance can be more closely watched.

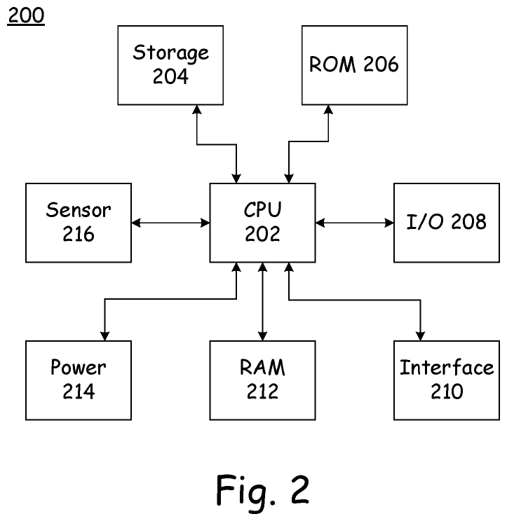

With reference now to FIG. 2, there is depicted one embodiment of a computerized apparatus 200 capable of performing the actions as described herein. In this embodiment, the apparatus 200 is locally under the control of the central processing unit 202, which controls and utilizes the other modules of the apparatus 200 as described herein. As used herein, the word module refers to a combination of both software and hardware that performs one or more designated function. Thus, in different embodiments, various modules might share elements of the hardware as described herein, and in some embodiments might also share portions of the software that interact with the hardware.

The embodiment of apparatus 200 as depicted in FIG. 2 includes, for example, a storage module 204 such as a hard drive, tape drive, optical drive, solid state drive, or some other relatively long-term data storage device. A read-only memory module 206 contains, for example, basic operating instructions for the operation of the apparatus 200. An input-output module 208 provides a gateway for the communication of data and instructions between the apparatus 200 and other computing devices, networks, or data storage modules. An interface module 210 includes, for example, keyboards, speakers, microphones, cameras, displays, mice, and touchpads, and touchscreens, and provides means by which the user can observe and control the operation of the apparatus 200.

A random-access memory module 212 provides short-term storage for data that is being buffered, analyzed, or manipulated and programming instructions for the operation of the apparatus 200. A power module 214 is also provided in various embodiments of the apparatus 200. In some embodiment that power module 214 is a portable power supply, such as one or more batteries. In some embodiments the power module 214 includes a renewable source, such as a solar panel or an inductive coil that are configured to provide power or recharge the batteries. In other embodiments the power module 214 receives power from an external power source, such as a 110/220 volt supply.

Some embodiments of the apparatus 200 include other sensors 216, which sense local properties such as motion, declination, direction, altitude, pressure, temperature, humidity, magnetic field, and so forth.

In one embodiment, the apparatus 200 shares hardware and software with a user's personal electronic device, as described in more detail above. In other embodiments, the apparatus 200 is an add-on device that monitors and otherwise works in conjunction with the user's electronic device. In either embodiment, the apparatus 200 performs the functions as described herein, and then sends the data out through the input/output 208 for remote storage or further processing, or directly to the storage module 204. In some embodiments the steps of the method as described herein are embodied in a computer language on a non-transitory medium that is readable by the apparatus 200 of FIG. 2, and that enables the apparatus 200 to implement the process as described herein.

The foregoing description of embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A method for detecting and acting upon a variance in an electronic device of a user, the method comprising the steps of:
monitoring operation of the electronic device for anomalies in streams of at least one of visual, audio, or haptic data to locate a variance in at least one of video frames, audible frequencies, and haptic patterns,
recording the variance,
alerting the user to the variance,
receiving a confirmation from the user in regard to the variance, and
initiating a response to the variance in associated electronic devices.

2. The method of claim 1, wherein the anomalies comprise an image that is presented for less than a given length of time and the image differs from a preceding image and a succeeding image by more than a given amount.

3. The method of claim 2, wherein the given length of time is about one second.

4. The method of claim 1, wherein the anomalies comprise a series of audio tones that is presented for less than a given length of time and the series of audio tones differs from a preceding series of audio tone and a succeeding series of audio tones by more than a given amount.

5. The method of claim 4, wherein the given length of time is about one second.

6. The method of claim 1, wherein the anomalies comprise a haptic signal that is unrelated to the user's operation of the electronic device.

7. An apparatus for detecting and acting upon a variance in an electronic device of a user, the apparatus comprising:
a processor for monitoring operation of the electronic device for anomalies in streams of at least one of visual, audio, or haptic data to locate a variance in video frames, audible frequencies, and haptic patterns,
a memory for recording the variance,
an interface for alerting the user to the variance,
the interface further for receiving a confirmation from the user in regard to the variance, and
an output for initiating a response to the variance in associated electronic devices.

8. The apparatus of claim 7, wherein the anomalies comprise an image that is presented for less than a given length of time and the image differs from a preceding image and a succeeding image by more than a given amount.

9. The apparatus of claim 8, wherein the given length of time is about one second.

10. The apparatus of claim 7, wherein the anomalies comprise a series of audio tones that is presented for less than a given length of time and the series of audio tones differs from a preceding series of audio tone and a succeeding series of audio tones by more than a given amount.

11. The apparatus of claim 10, wherein the given length of time is about one second.

12. The apparatus of claim 7, wherein the anomalies comprise a haptic signal that is unrelated to the user's operation of the electronic device.

13. A non-transitory, computer-readable storage medium having stored thereon a computer program comprising a set of instructions for causing the computer to perform the steps of:
monitoring operation of an electronic device for anomalies in streams of at least one of visual, audio, or haptic data to locate a variance in video frames, audible frequencies, and haptic patterns,
recording the variance,
alerting a user to the variance,
receiving a confirmation from the user in regard to the variance, and
initiating a response to the variance in associated electronic devices.

14. The non-transitory, computer-readable storage medium of claim 13, wherein the anomalies comprise an image that is presented for less than a given length of time and the image differs from a preceding image and a succeeding image by more than a given amount.

15. The non-transitory, computer-readable storage medium of claim 14, wherein the given length of time is about one second.

16. The non-transitory, computer-readable storage medium of claim 13, wherein the anomalies comprise a series of audio tones that is presented for less than a given length of time and the series of audio tones differs from a preceding series of audio tone and a succeeding series of audio tones by more than a given amount.

17. The non-transitory, computer-readable storage medium of claim 16, wherein the given length of time is about one second.

18. The non-transitory, computer-readable storage medium of claim 13, wherein the anomalies comprise a haptic signal that is unrelated to the user's operation of the electronic device.
